(19) United States
(12) Patent Application Publication
(10) Pub. No.: US 2024/0092440 A1
(43) Pub. Date: Mar. 21, 2024

(54) TRACTOR GROUPING WITH DRIVEN TRAILER

(71) Applicant: ZF Friedrichshafen AG, Friedrichshafen (DE)

(72) Inventors: Rico Glöckner, Pocking (DE); Migen Bebeti, München (DE)

(73) Assignee: ZF Friedrichshafen AG, Friedrichshafen (DE)

(21) Appl. No.: 18/256,507

(22) PCT Filed: Dec. 8, 2021
(86) PCT No.: PCT/EP2021/084721

§ 371 Date: Jun. 8, 2023

(30) Foreign Application Priority Data
Dec. 18, 2020 (DE) 10 2020 216 271.9

(51) Int. Cl. B62D 59/04; B60K 1/04; B60K 17/02; B60L 15/20

(52) U.S. Cl. CPC B62D 59/04; B60K 1/04; B60K 17/02; B60L 15/20; H02P 27/06

(57) ABSTRACT

A tractor-trailer combination (10) includes a tractor machine (12), a trailer (14; 40; 50; 60; 70; and an inverter (30; 100, 102). The trailer (14; 40; 50; 60; 70; 90) comprises a driven axle (18; 42; 72, 74; 92, 94), a clutch (46; 54, 56; 78; 104, 106), and an electric traction motor (24; 96, 98). The traction motor (24; 96, 98) drives the respective wheels of the driven axle (18; 42; 72, 74; 92, 94) via the clutch (46; 54, 56; 78; 104, 106). The tractor machine (12) comprises an electrical energy source (26) for supplying the traction motor (24; 96, 98) via the inverter (30; 100, 102). In addition, the invention relates to a trailer (14; 40; 50; 60; 70; 90) for a tractor-trailer combination (10).

### RELATED APPLICATIONS

This application claims the benefit under 35 U.S.C. § 371 as a U.S. National Phase Application of application no. PCT/EP2021/084721, filed on 8 Dec. 2021, which claims benefit of German Patent Application no. 10 2020 216 271.9 filed 18 Dec. 2020, the contents of which are hereby incorporated herein by reference in their entireties.

### TECHNICAL FIELD

The present invention relates to a tractor-trailer combination comprising a tractor machine and a trailer coupled thereto. In addition, the invention relates to a trailer for a tractor-trailer combination.

### PRIOR ART

A tractor-trailer combination comprising a tractor machine and a trailer coupled thereto is usually driven only by the tractor machine, which then pulls the trailer when driving forward and pushes it when driving in reverse. In addition, the trailer also can be driven. However, such a design can entail high costs and reduce the space available in the trailer for equipment and goods transported. Furthermore, in such a case a maximum driving speed can be restricted due to a driving range of the drive system of the trailer. Likewise, an efficiency of the tractor-trailer combination can be low, at least in some driving situations, owing to the drive system in the trailer.

### EXPLANATION OF THE INVENTION

A first aspect of the invention relates to a tractor-trailer combination comprising a tractor machine, a trailer coupled thereto and an electric inverter. The trailer has at least one driven axle with respective wheels, at least one clutch and at least one electric traction motor. The traction motor is designed, by way of the at least one clutch, to act upon the respective wheels of the at least one driven axle with a driving force. The tractor machine comprises a source of electrical energy designed to supply the traction motor of the trailer with electrical energy via the inverter. In that way the trailer is driven.

By virtue of such a design the tractor-trailer combination can be particularly powerful. For example, its cross-country mobility can be increased to a level similar to all-wheel passenger cars due to the additionally driven axle of the trailer. The use of an electric traction motor enables a space-saving structure and simple energy supply via the tractor machine. Thus, there is no need for an energy source in the trailer. The clutch makes it possible to change the driving mode of the trailer to a freewheeling condition, so that even high driving speeds are possible, for which the drive system of the tractor machine but not that of the trailer are designed. For example, on steep inclines and alternatively or in addition for cross-country driving at low speeds, the traction motor of the trailer is designed to provide assistance and is correspondingly designed. On the other hand, at high driving speeds such as on country roads, the traction motor of the trailer can be decoupled from the driven axle and alternatively or in addition from its wheels in order to avoid towing losses and other undesired reactions with the traction motor of the trailer. The traction motor can drive all the respective wheels of an axle together. Thus, there is no need for a traction motor for each wheel or for each side of a driven axle of the trailer. Thus, the number of costly electric motors can be kept small despite having a driven axle on the trailer. Accordingly, the number of inverters can also be small compared with a wheel-hub drive system on a trailer.

The tractor machine can comprise a drive unit, which for example can be in the form of an internal combustion engine or an electric traction motor. The tractor machine can have one or more driven axles with their respective wheels. The tractor machine can in addition have one or more non-driven axles with their wheels. The energy source can be in the form of a generator of the drive unit, which for example is connected to the internal combustion engine, or in the form of an energy accumulator such as a battery connected to the electric traction motor of the tractor machine, or a hydrogen cell. The energy source can also be designed to supply electrical energy to a traction motor of the trailer and alternatively or in addition to further electric consumers, in particular to attachments or to the traction motor of the tractor machine. For example, the energy source can be designed to provide a power of at least 5 kW, 10 kW, 15 kW or more. The tractor machine can be designed to control the tractor-trailer combination. For example, the energy source can be designed to deliver alternating current and, alternatively or in addition, direct current. The inverter can for example be in the form of a converter or a power inverter.

Thanks to the electric traction motor, a drive system is provided in the trailer. The drive unit of the tractor machine can for example cover a driving range different from that of the drive system of the trailer. In such a case the drive ranges can even partially or completely overlap, in order to be able to deliver increased power. For example, the driving range of the trailer can correspond to a slow driving range of the tractor machine so that during cross-country driving it can deliver a high torque and also improve the cross-country mobility by driving more than one axle. For example, the driving range of the drive unit of the tractor machine can be designed for high-speed driving, as on country roads, and optionally also for slow driving, wherein the said slow driving range can correspond partially or completely to the driving range of the drive system of the trailer. For example, the driving range can be a speed range or a torque. Each driving range can be obtained in one or more gears of a transmission.

The drive system of the trailer can also comprise a transmission. The electric traction motor can be in the form of a central drive unit which, for example, drives all the wheels of one or more axles. The tractor machine and the trailer can have matching electrical connections which, when coupled, enable the electric traction drive of the trailer to be supplied from the tractor machine. Accordingly, respective control lines for the control of the electric traction motor of the trailer by the control system in the tractor machined can be provided. The tractor machine and the trailer can have matching mechanical couplings whose coupling enables the trailer to be towed by the tractor machine. The connection between the tractor machine and the trailer can be designed in such manner that electrical and mechanical coupling take place at the same time. Each coupling can be designed to be releasable.

The tractor machine can for example be in the form of an agricultural machine such as an agricultural tractor or a harvester. The trailer can be designed, for example, for the transport of agricultural products, such as cereals. For example, the trailer can be designed not to be operable unless it is coupled to the tractor machine. The coupling can be adjustable, for example, mechanically, electrically, hydraulically, or pneumatically. For that purpose, the trailer can also be connected to an appropriate source of compressed air, hydraulic oil, or electrical energy in the tractor machine. For example, a hydraulic or pneumatic coupling between the tractor machine and the trailer can be provided in order to be able to actuate the said coupling. The at least one clutch can be, for example, in the form of a disk clutch, a dry clutch, or a claw clutch. By virtue of the said clutch the electric traction motor can be coupled, for example, to the axle or uncoupled therefrom, and alternatively or in addition to or from the wheels of the said axle. In an uncoupled condition, the drive system of the trailer can freewheel and reactions can be avoided.

The inverter can be designed to control the traction motor of the trailer and optionally also control a traction motor of the tractor machine. An additional control unit can also be provided. The inverter can be supplied, for example, from an intermediate circuit of the tractor machine. The intermediate circuit can be supported by an electric tapping performance interface. The intermediate circuit can be buffered, for example, with a battery. The buffering battery can be fitted on the tractor machine or the trailer. In that way, above-average performances can be called up for brief periods. The axles or wheels that can be acted upon by driving force are called driven axles or driven wheels.

The trailer can have a plurality of driven axles and alternatively or in addition one or more non-driven axles. Differentials can be provided on the respective axles of the trailer and also on the tractor machine, or those axles can not have differentials. Instead of a differential, for example a bevel gear with 100% locking ratio or one that differs therefrom can be provided. On each axle one or more wheels can be fitted at each end. One end can be on the left and the opposite end on the right. The axles can be through-going, or even divided.

In an embodiment of the tractor-trailer combination, it can be provided that the trailer has a transmission, by way of which the traction motor of the trailer acts upon the respective wheels of the at least one driven axle with a driving force. By virtue of the transmission, the traction motor can act, for example, upon the axles in a stepped-down manner. The transmission can also be designed to transmit a driving force of the traction motor to more than one driven axles of the trailer. The transmission can be designed such that one or more axles of the trailer are driven by its traction motor. Thereby, in a simple manner a central traction motor can be provided. This is simpler to supply with electrical energy than respective decentralized traction motors for each axle or for each wheel. The transmission can for example be in the form of a two-stage transmission or it can have a plurality of stages. The transmission can be designed to accommodate the traction motor of the trailer, so that there is no need for a separate, costly mounting that takes up a lot of space.

The transmission and the traction motor of the trailer can be designed, respectively, identically to a transmission of the tractor machine and, alternatively or in addition, to a traction motor of the tractor machine. In that way, many identical components can be used in the tractor-trailer combination. The tractor-trailer combination can be an all-wheel system without rotation speed equalization between the driven axles on the tractor machine and driven axles on the trailer. Thus, no differential compensation need be provided. Thereby, the tractor-trailer combination can be produced more inexpensively.

In an embodiment of the tractor-trailer combination, it can be provided that the at least one clutch is arranged in the power flow between the traction motor and the at least one driven axle. By virtue of such a central clutch, the number of respective clutches can be kept small, with positive effects on costs and fitting space. The power flow can correspond to a transmission of torque from the traction motor to the wheels of the driven axle of the trailer. For each driven axle an associated clutch can be provided, or alternatively only a single clutch can be provided between the traction motor and two, several, or all of the axles driven by it. The control of a single clutch is particularly simple.

In an embodiment of the tractor-trailer combination, it can be provided that the trailer has two clutches for at least one of the driven axles, each of them arranged on an associated side in the power flow between the at least one driven axle and in each case the wheels of the said axle. For example, in the case of a driven axle a clutch can be provided on the left and a clutch can be provided on the right. By means of such clutches, in each case the wheels can be decoupled from the driven axle concerned to enable freewheeling. Such a structure is particularly efficient and can achieve low drag losses when the drive system of the trailer is not being used, for example when driving along a country road. Furthermore, the respective clutches can be arranged close to the wheel hubs, on which the traction motor does not have to be arranged. In that way a central useful space of the trailer can be restricted only slightly or even not at all by the clutches.

In an embodiment of the tractor-trailer combination, it can be provided that the traction motor of the trailer is designed to apply the driving force to the respective wheels of the two driven axles of the trailer. The traction motor can also be designed to drive three or more axles of the trailer. In that way the number of traction motors, electrical components and the overall complexity of the drive control system can remain small, even though several axles of the trailer are being driven. In this case one or two clutches can be provided for each traction motor or for each driven axle, in order to be able to couple or decouple driven axles or wheels as necessary.

In an embodiment of the tractor-trailer combination, it can be provided that the trailer has at least two electric traction motors, each of which is designed to apply a driving force to the respective wheels of an associated driven axle of the trailer. The associated axles can be different axles. In this way, a drive system particularly well suited to requirements can be provided. For example, each traction motor can be provided for a different driving range. Moreover, the traction motors can be very small and designed for low power, which can affect both costs and fitting space positively. For example, in each case one of two driven axles can be driven by a respective traction motor. However, for example, a shared traction motor can be provided for two driven axles and an additional traction motor can be provided for a further driven axle.

In an embodiment of the tractor-trailer combination, it can be provided that the two traction motors of the trailer are designed to cover different driving ranges. The traction motor of the first axle, for example, can be designed for a driving range different from that of the other axle. An example is a slow-driving range and a fast-driving range. Each traction motor can be connected by means of an associated clutch. The driving range can be a speed range or a torque, for example. Different driving ranges can mean different bandwidths with an overlap, or there may not be any overlap.

In an embodiment of the tractor-trailer combination, it can be provided that for each traction motor of the trailer the tractor-trailer combination has an associated inverter, by way of which the motor is in each case connected to the energy source. In that way, for example, there is no need for a separate motor control system. Furthermore, the inverter can be designed such that it is adapted to the traction motor concerned.

In an embodiment of the tractor-trailer combination, it can be provided that the tractor-trailer combination has a common associated inverter for at least two traction motors of the trailer, by way of which the motors are connected to the energy source. In that way, the number of costly inverters can be reduced. It can also simplify the arrangement of the inverter on the tractor machine. For example, one inverter can be provided for all the traction motors of the trailer. However, for example one inverter can also be provided for two traction motors of the trailer and a further inverter can be provided for a further traction motor of the trailer.

In an embodiment of the tractor-trailer combination, it can be provided that at least one of the driven axles has a differential so as to enable different rotation speeds of the wheels at the respective ends of the axle concerned. This can allow different fast rotation speeds of the wheels at opposite sides of the driven axle. The differential can have a locking function in order to simplify cross-country driving. For example, the differential can enable more rapid cornering. The differential can also be designed for self-locking.

Respective driven and alternatively or in addition non-driven axles of the trailer can also not have a differential. Such a structure is cheaper and robust. For example, on each of the respective driven axles which do not have a differential, a bevel gear can be provided for connection to an output shaft of the traction motor.

In an embodiment of the tractor-trailer combination, it can be provided that at least one of the respective inverters is arranged on the tractor machine. For example, even all the inverters can be arranged on the tractor machine. This can have cost advantages during maintenance and manufacture, in particular relating to the arrangement of power electronics and alternatively or additionally control units in the tractor machine.

In an embodiment of the tractor-trailer combination, it can be provided that at least one of the respective inverters is arranged on the trailer. For example, even all the inverters can be arranged on the trailer. Such a structure facilitates retrofitting of a driven trailer to a tractor-trailer combination. Furthermore, the tractor machine can be combined with inexpensive, non-driven trailers without entailing costly and elaborate technology for trailers which are driven. The said costly technology can then for the most part be concentrated in the driven trailers.

In an embodiment of the tractor-trailer combination, it can be provided that the trailer comprises at least one non-driven axle with respective wheels. In that way, for example, driving stability and the maximum load can be increased by simple means.

A second aspect of the invention relates to a trailer for a tractor-trailer combination. This can be a trailer of the tractor-trailer combination in accordance with the first aspect. Associated advantages and further characteristics then emerge from the descriptions relating to the first aspect.

The trailer according to the second aspect can comprise at least one driven axle with its wheels, at least one clutch and at least one electric traction motor, which is designed to apply a driving force to the respective wheels of the at least one driven axle via the at least one clutch. The traction motor of the trailer according to the second aspect can be designed to be supplied with electrical energy for driving the trailer, from an electrical energy source of a tractor machine of the tractor-trailer combination, via an inverter. The inverter can be part of the tractor machine or of the trailer.

### BRIEF DESCRIPTION OF THE FIGURES

FIG. 1 shows a schematic side view of a tractor-trailer combination, with a tractor machine and a trailer coupled thereto.

FIG. 2 shows a schematic view from above, of a first embodiment of the trailer of FIG. 1.

FIG. 3 shows a schematic view from above, of a second embodiment of the trailer of FIG. 1.

FIG. 4 shows a schematic view from above, of a third embodiment of the trailer of FIG. 1.

FIG. 5 shows a schematic view from above, of a fourth embodiment of the trailer of FIG. 1.

FIG. 6 shows a schematic view from above, of a fifth embodiment of the trailer of FIG. 1.

### DETAILED DESCRIPTION OF EMBODIMENTS

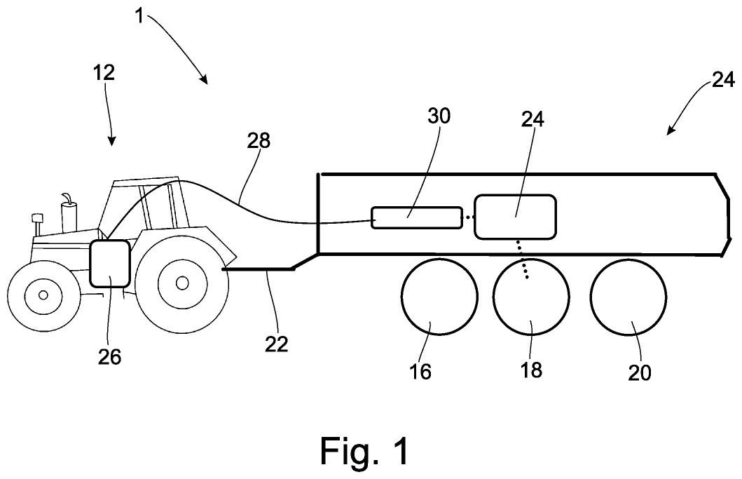

FIG. 1 illustrates in a schematic side view, a tractor-trailer combination 10 with a tractor machine 12 and a trailer 14 coupled thereto. The tractor machine 12 is for example in the form of an agricultural tractor and has two axles with respective wheels, of which at least one is driven by the drive unit of the tractor machine 12. Furthermore, the tractor machine 12 has a driver's cabin. In addition, the tractor machine 12 has an electrical energy source 26 such as a battery or a generator coupled to an internal combustion engine.

The trailer 14 has a front axle 16, a central axle 18 and a rear axle 20. On each of the axles 16, 18, 20 respective wheels are arranged. The trailer 14 is coupled detachably to the tractor machine 12 by means of a mechanical trailer hitch 22 so that the tractor machine 12 can tow the trailer 14. Furthermore, the trailer 14 has a drive system such that, in the example shown, only the central axle 18 is a driven axle 18. The trailer 14 has an electric traction motor 24, which is designed to apply a driving force to the respective wheels of the driven axle 18. In this case, the traction motor 24 can be connected by a clutch to the rest of the drive-train of the trailer 14, so that the traction motor 24 can be decoupled to enable freewheeling with reduced drag losses. The traction motor 24 can drive the wheels on both sides of the axle 18, in contrast to a design with wheel-hub motors. To control the clutch, for example, a compressed-air source, a hydraulic output or an electrical output is provided on the trailer 14. The compressed air, hydraulic output or electrical output can for example be supplied from the tractor machine 12.

The source of electrical energy 26 is designed to deliver sufficient electrical power for the traction motor 24 of the trailer 14. The energy source 26 is connected to the traction motor 24 by an electric line 28 between the tractor machine 12 and the trailer 14, which line can be separate from the trailer hitch 22 or integrated in the latter. Moreover, the energy source 26 is connected to the traction motor 24 via an inverter 30. Since the traction motor 24 acts upon the driven axle 18 and not directly upon the respective wheels associated with that axle, as is the case with a one-wheel drive system, one traction motor 24 and one inverter 30 suffice to provide a drive system for the trailer 14.

As shown, the inverter 30 can be arranged on the trailer 14, or else on the tractor machine 12. The inverter 30 can be fed from an intermediate circuit of the electrical system of the tractor machine 12. The intermediate circuit can be assisted by a tapping interface. The intermediate circuit can additionally be buffered by a battery. The traction motor 24 can be connected to the driven axle 18 by a one-stage or a multi-stage transmission.

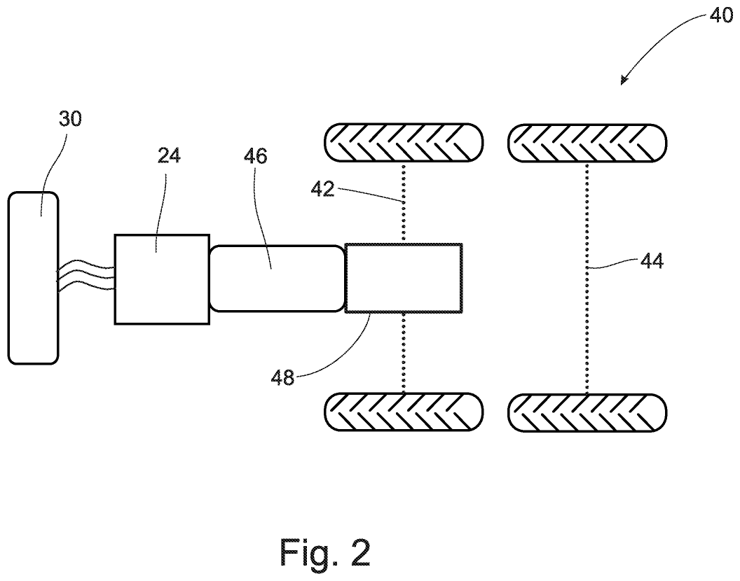

FIGS. 2 to 6 illustrate alternative embodiments, in each case showing a schematic view of the trailer 14 as seen from above. Components of the same type can be provided with the same indexes, and only differences and special features of the respective embodiments are explained for purposes of comparison. The said further embodiments of the trailer can each be coupled for their operation to the tractor machine 12 in order to form a tractor-trailer combination.

The trailer 40 shown in FIG. 2 comprises two axles 42, 44 with their respective wheels, wherein only the front axle 42 is driven by the traction motor 24. The traction motor 24 is connected via a clutch 46 to a differential 48 of the driven axle 42. Thanks to the clutch 46, the axle 42 can freewheel without reactions in the traction motor 24. The clutch, for example, can be in the form of a disk clutch, a dry clutch, or a claw clutch, and it can be designed, for example, to be engaged pneumatically, electrically, or hydraulically. The differential can enable the wheels on the two sides of the axle 42 to rotate at different speeds, and thereby, for example, to improve the cornering behavior. In addition, the differential 48 is connected to the traction motor 24 or the interposed clutch 46 in order to enable the driving force to be transmitted to the wheels.

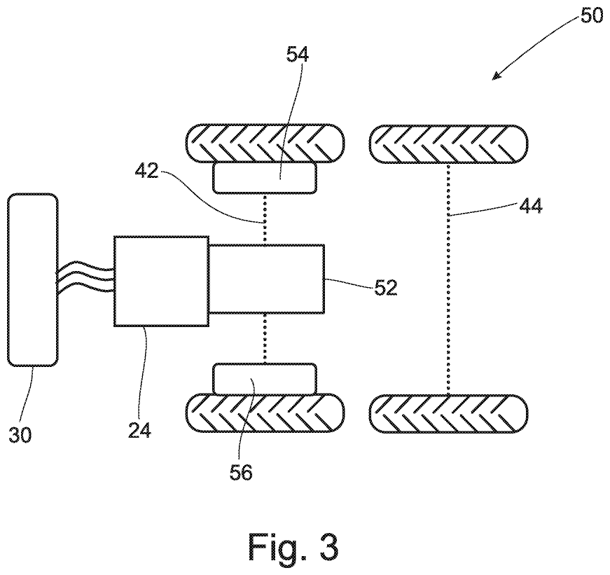

FIG. 3 shows a trailer 50, whose structure differs from the trailer 40 in its differential 52 and in having a first clutch 54 and a second clutch 56. The differential 52 comprises an integrated differential lock or a self-locking function. In the trailer 50 the traction motor 24 is connected to the differential 52. The first clutch 54 enables a releasable connection of the right-hand wheel to the axle 42 and the second clutch 56 enables a releasable connection of the left-hand wheel to the axle 42. In that way the two wheels can be disengaged directly to a freewheeling mode so that in the trailer 50, when idling, the axle 42 no longer co-rotates as it does in the trailer 40. In addition, by virtue of the differential lock or the self-locking function one side of the axle 42 can be decoupled and the driving force transmitted in its entirety to the other side. This can simplify a resumption of the travel movement of a tractor-trailer combination which has become stuck fast in mud, for example.

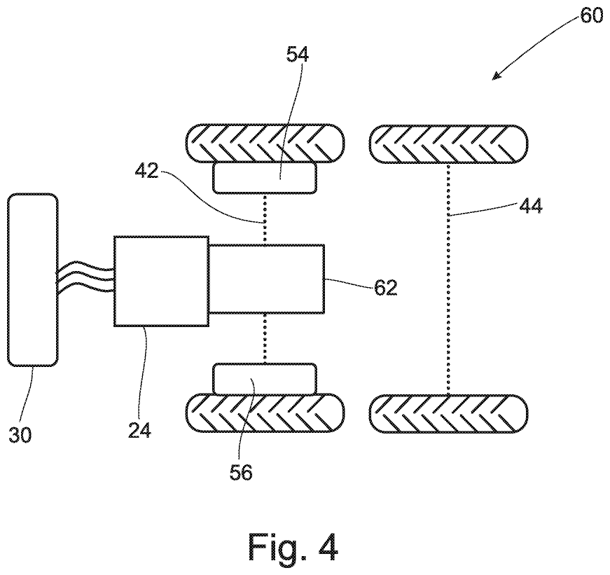

FIG. 4 shows a trailer 60 whose structure differs from the trailer 50 in that no differential is provided. Instead, the trailer 60 comprises a bevel gear 62 which corresponds to a differential with 100% locking action and connects the traction motor 24 to the driven axle 42.

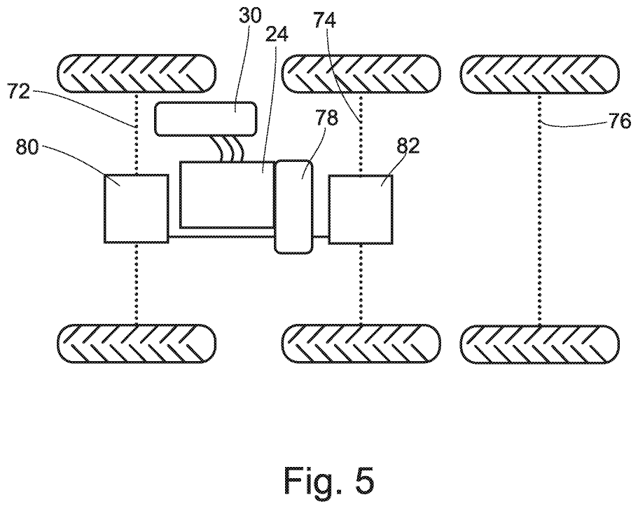

FIG. 5 shows a trailer 70 with two axles 72, 74, both of which are driven by the shared traction motor 24, as well as a non-driven axle 76. Between the two driven axles 72, 74 a longitudinal differential can be provided, or the rotation speed ratio of the two driven axles 72, 74 can be fixed, as shown in the example. In the example shown, the traction motor 24 can be connected to and decoupled from the two driven axles 72, 74 by way of a clutch 78. In another embodiment, each of the driven axles 72, 74 can be detachably connected to the traction motor 24 by a respectively associated clutch. From this it can be seen that the particular special features of the various embodiments can be combined with one another (here, for example, the features of trailer 50 and trailer 70), whereby further embodiments will emerge within the scope of the present disclosure. The two drive axles 72, 74 can be connected, for example, to the traction motor 24, each of which has an associated differential 80, 82, and by way of the clutch 78, whereby different rotation speeds of the wheels are made possible on the left side and on the right side of each driven axle 72, 74. Instead of the respective differentials, however, a bevel gear can be provided in each case.

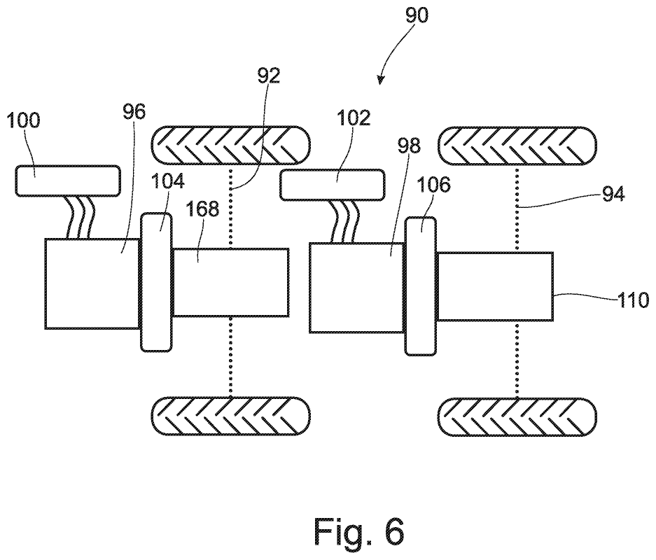

FIG. 6 shows a trailer 90 with two driven axles 92, 94. Each driven axle 92, 94 is in this case associated with a traction motor 96, 98. Each traction motor 96, 98 is supplied with electrical energy from the energy source 26 of the tractor machine 12 via an associated inverter 100, 102. In other embodiments, the respective inverters 100, 102 can be installed on the tractor machine 12 and alternatively or in addition the two traction motors 96, 98 can be supplied with electrical energy via a common inverter. The two traction motors 96, 98 can be detachably coupled to the respective driven axles 92, 94, in each case via an associated clutch 104, 106. Alternatively, in each case, two clutches can be provided on one or both axles 92, 94 for the detachable connection of the wheels on the two sides. The two axles 92, 94 each have a differential 108, 110, although on one or both of the two axles 92, 94 a bevel gear drive could also be provided.

### INDEXES

10 Tractor-trailer combination
12 Tractor machine
14; 40; 50; 60; 70; 90 Trailer
16, 20; 44; 76 Axle
18; 42; 72, 74; 92, 94 Driven axle
22 Mechanical trailer hitch
24, 96, 98 Traction motor
26 Electrical energy source
28 Electrical connection
30, 100, 102 Inverter
46; 54, 56; 78; 104, 106 Clutch
48; 52; 80, 82; 108, 110 Differential
62 Bevel gear

1. A tractor-trailer combination (10) comprising:
a tractor machine (12);
a trailer (14; 40; 50; 60; 70; 90) coupled thereto and to the tractor machine; and
an electrical inverter (30; 100, 102), wherein the trailer (14; 40; 50; 60; 70; 90) comprises at least one driven axle (18; 42; 72, 74; 92, 94) with respective wheels, at least one clutch (46; 54, 56; 78; 104, 106), and at least one electric traction motor (24; 96, 98) configured to act upon the respective wheels of the at least one driven axle (18; 42; 72, 74; 92, 94) with a driving force by way of the at least one clutch (46; 54, 56; 78; 104, 106), wherein the tractor machine (12) comprises an electrical energy source (26) configured to supply the at least one electric traction motor (24; 96, 98) of the trailer (14; 40; 50; 60; 70; 90) via the inverter (30; 100, 102) in order to drive the trailer (14; 40; 50; 60; 70; 90).

2. The tractor-trailer combination (10) according to claim 1, wherein the trailer (14; 40; 50; 60; 70; 90) comprises a transmission configured to act with a driving force on the respective wheels of the at least one driven axle (18; 42; 72, 74; 92, 94) by way of the traction motor (24; 96, 98) of the trailer (14; 40; 50; 60; 70; 90).

3. The tractor-trailer combination (10) according to claim 1, wherein the at least one clutch (46; 78; 104, 106) is arranged in a power flow between the traction motor (24; 96, 98) and the at least one driven axle (18; 42; 72, 74; 92, 94).

4. The tractor-trailer combination (10) according to claim 3, wherein the trailer (50; 60) comprises two clutches (54, 56) for the at least one of the driven axles (18; 42), each of of the two clutches arranged on an associated side in a power flow between the at least one driven axle (18; 42) and the respective wheels of the said axle (18; 42).

5. The tractor-trailer combination (10) according to claim 1, wherein the trailer (70; 90) has at least two driven axles (72, 74; 92, 94) each having respective wheels.

6. The tractor-trailer combination (10) according to claim 5, wherein the at least one electric traction motor (24) of the trailer (70) is configured and arranged to act upon the respective wheels of the two driven axles (72, 74) of the trailer (70) with the driving force.

7. The tractor-trailer combination (10) according to claim 6, wherein the trailer (90) has two electric traction motors (96, 98), each designed to act upon the respective wheels of an associated driven axle (96, 98) of the trailer (90) with a driving force.

8. The tractor-trailer combination (10) according to claim 7, wherein the two electric traction motors (96, 98) of the trailer (90) are designed to provide different driving ranges.

9. The tractor-trailer combination (10) according to claim 1, wherein for each at least one electric traction motor (24; 96, 98) has an associated inverter (30; 100, 102) by way of which each at least one traction motor is connected to the electrical energy source (26).

10. The tractor-trailer combination (10) according to claim 1, wherein the at least one electric traction motor includes at least two electric traction motors (96, 98), the trailer (90) the tractor-trailer combination (10) further comprising an associated common inverter by way of which the at least two electric traction motors are connected to the electrical energy source (26).

11. The tractor-trailer combination (10) according to claim 1, wherein at least one of the at least one driven axle (18; 42; 72, 74; 92, 94) comprises a differential (48; 52; 80, 82; 108, 110) configured to enable different rotation speeds of the respective wheels at the different ends of the said at least one driven axle (18; 42; 72, 74; 92, 94).

12. The tractor-trailer combination (10) according to claim 1, wherein the at least one of the electrical inverter is arranged on the tractor machine (12).

13. The tractor-trailer combination (10) according to claim 1, wherein the electrical inverter (30; 10, 102) is arranged on the trailer (14; 40; 50; 60; 70; 90).

14. The tractor-trailer combination (10) according to claim 1, wherein the trailer (14; 40; 50; 60; 70) comprises at least one non-driven axle (16; 20; 44; 76) with respective wheels.

15. A trailer (14; 40; 50; 60; 70; 90) for a tractor-trailer combination (10), wherein the trailer (14; 40; 50; 60; 70; 90) comprises:
at least one driven axle (18; 42; 72, 74; 92, 94) with respective wheels;
at least one clutch (46; 54, 56; 78; 104, 106); and
at least one electric traction motor (24; 96, 98) configured to act upon the respective wheels of the at least one driven axle (18; 42; 72, 74; 92, 94) via the at least one clutch (46; 54, 56; 78; 104, 106) with a driving force, wherein the at least one electric traction motor (24; 96, 98) is configured to be supplied with electrical energy from an electrical energy source (26) of a tractor machine (12) of the tractor-trailer combination (10) via an inverter (30; 100, 102) in order to drive the trailer (14; 40; 50; 60; 70; 90).
